(19) United States
(12) Patent Application Publication
(10) Pub. No.: US 2024/0127387 A1
(43) Pub. Date: Apr. 18, 2024

(54) INFORMATION PROCESSING APPARATUS, INFORMATION PROCESSING METHOD, AND STORAGE MEDIUM

(71) Applicant: TOYOTA JIDOSHA KABUSHIKI KAISHA, Toyota-shi (JP)

(72) Inventors: Katsunori TAKAHASHI, Kashiwa-shi (JP); Akie SAKIYAMA, Shinjuku-ku (JP); Nobuto MATSUDAIRA, Minato-ku (JP); Haruna FUKUSHIMA, Kawasaki-shi (JP); Yohei MIMURA, Minato-ku (JP); Takuya MURAKAMI, Minato-ku (JP); Yasushi MATSUOKA, Minato-ku (JP); Kazuki NAGASHIMA, Taito-ku (JP); Hideyuki KASAI, Minato-ku (JP); Toshiyasu MURAYAMA, Kita-ku (JP)

(73) Assignee: TOYOTA JIDOSHA KABUSHIKI KAISHA, Toyota-shi (JP)

(21) Appl. No.: 18/489,285

(22) Filed: Oct. 18, 2023

(30) Foreign Application Priority Data
Oct. 18, 2022 (JP) 2022-166775

(51) Int. Cl. G06Q 50/30; G06Q 30/0201

(52) U.S. Cl. CPC G06Q 50/30; G06Q 30/0201

(57) ABSTRACT

An information processing apparatus comprises a controller, the controller being configured to execute: acquiring pieces of result data showing movement results of a plurality of users; calculating at least either first evaluation values about convenience in a case of moving in predetermined sections in private vehicles or second evaluation values about convenience in a case of moving in the predetermined sections in public transportation at least based on the pieces of result data; and calculating, for a predetermined area, a score indicating a deviation between convenience in the case of moving in the private vehicles and convenience in the case of moving in the public transportation based on the first and second evaluation values.

### CROSS REFERENCE TO THE RELATED APPLICATION

This application claims the benefit of Japanese Patent Application No. 2022-166775, filed on Oct. 18, 2022, which is hereby incorporated by reference herein in its entirety.

### BACKGROUND

### Technical Field

The present disclosure relates to a technique for analyzing convenience of transportation.

### Description of the Related Art

There is a technique for improving convenience of movement.

Regarding the technique, for example, Japanese Patent Laid-Open No. 2021-67975 discloses a system for deciding an optimal vehicle to be arranged at a car sharing station.

### SUMMARY

An object of the present disclosure is to analyze convenience of transportation.

The present disclosure in its one aspect provides an information processing apparatus comprising a controller, the controller being configured to execute: acquiring pieces of result data showing movement results of a plurality of users; calculating at least either first evaluation values about convenience in a case of moving in predetermined sections in private vehicles or second evaluation values about convenience in a case of moving in the predetermined sections in public transportation at least based on the pieces of result data; and calculating, for a predetermined area, a score indicating a deviation between convenience in the case of moving in the private vehicles and convenience in the case of moving in the public transportation based on the first and second evaluation values.

The present disclosure in its another aspect provides an information processing method comprising the steps of: acquiring pieces of result data showing movement results of a plurality of users; calculating at least either first evaluation values about convenience in a case of moving in predetermined sections in private vehicles or second evaluation values about convenience in a case of moving in the predetermined sections in public transportation at least based on the pieces of result data; and calculating, for a predetermined area, a score indicating a deviation between convenience in the case of moving in the private vehicles and convenience in the case of moving in the public transportation based on the first and second evaluation values.

As other aspects, a program for causing a computer to execute the above method, or a computer-readable storage medium that non-transitorily stores the program are exemplified.

According to the present disclosure, it is possible to analyze convenience of transportation.

### BRIEF DESCRIPTION OF THE DRAWINGS

FIG. 1 is a schematic diagram of a vehicle system according to a first embodiment;

FIG. 2 is a diagram illustrating components of an onboard apparatus;

FIG. 3 illustrates an example of trip data transmitted from the onboard apparatus;

FIG. 4 is a diagram illustrating components of a server apparatus;

FIG. 5 is a diagram for illustrating divided unit areas;

FIG. 6 is a diagram illustrating a flow of a process for calculating a mobility gap score;

FIG. 7A is a diagram illustrating a mobility gap score calculation method;

FIG. 7B is a diagram illustrating the mobility gap score calculation method;

FIG. 8 is a diagram illustrating the mobility gap score calculation method;

FIG. 9 is a diagram illustrating the mobility gap score calculation method;

FIG. 10 is a diagram illustrating the mobility gap score calculation method;

FIG. 11 is a flowchart of a process executed by the server apparatus;

FIG. 12 illustrates an example of weight data in a second embodiment; and

FIG. 13 illustrates an example of a process of step S17 in the second embodiment.

### DESCRIPTION OF THE EMBODIMENTS

There is a demand to improve convenience of movement of users who reside in a particular area. The convenience of movement can be improved, for example, by shortening a time required from a departure point to a destination point and shortening a time required until starting movement. As measures for improving the convenience, for example, on-demand operation of a shared automobile and new arrangement of a car-sharing station can be exemplified.

At the time of making a plan for the above, it is necessary to conduct a survey in advance, for example, about in which area transportation is inconvenient. It is, however, difficult to determine whether movement needs of people who reside in an area only by information about availability of public transportation. Further, it is difficult to quantitatively evaluate to what degree convenience is damaged by lack of transportation means.

An information processing apparatus according to the present disclosure solves such a problem.

An information processing apparatus according to a first aspect of the present disclosure includes a controller, the controller being configured to execute: acquiring pieces of result data showing movement results of a plurality of users; calculating at least either first evaluation values about convenience in a case of moving in predetermined sections in private vehicles or second evaluation values about convenience in a case of moving in the predetermined sections in public transportation at least based on the pieces of result data; and calculating, for a predetermined area, a score indicating a deviation between convenience in the case of moving in the private vehicles and convenience in the case of moving in the public transportation based on the first and second evaluation values.

The pieces of result data are data indicating movement results of a plurality of users (typically, residents; in the present disclosure, referring to people who move in a region). It is favorable that the pieces of result data include pieces of position information about departure points and arrival points. Such pieces of data may be, for example, pieces of data transmitted from a plurality of vehicles that are private vehicles. For example, pieces of position information about points where travel systems are started and points where the travel systems are shut down may be received from the plurality of vehicles. If it is possible to track movements of the users, the pieces of result data do not necessarily have to include the pieces of information about the departure points and the arrival points.

In the description below, a pair of a departure point and an arrival point will be referred to as a trip.

The controller calculates at least either evaluation values (the first evaluation values) about convenience in the case of moving for predetermined trips in private vehicles or evaluation values (the second evaluation values) about convenience in the case of moving for the trips in public transportation based on the pieces of result data. The convenience can be, for example, a time required for movement. In this case, the first and second evaluation values are values based on the time required for movement. The convenience is not limited to the time required for movement. For example, trouble required for the movement, costs required for the movement, the number of transfers, or the like may be used as each evaluation value.

It is possible to determine, for a particular trip, a deviation between convenience in the case of moving in a private vehicle and convenience in the case of moving in public transportation based on the first and second evaluation values. For example, it is possible to determine how much the time required in the case of moving in the private vehicle deviates in comparison with the time required in the case of moving in the public transportation.

For example, it is assumed that, for a certain trip, thirty minutes was required for movement in a private vehicle, and sixty minutes was required for movement in public transportation. In this case, it can be said that, for this trip, the convenience in the case of using the private vehicle and the convenience in the case of using the public transportation significantly deviate from each other. In description below, a convenience deviation will be referred to as a mobility gap. Further, a value indicating a degree of deviation will be referred to as a mobility gap score or simply as a score.

A mobility gap score can be determined for each pair of a departure point and an arrival point. When there are a plurality of pieces of result data including a plurality of trips, a plurality of pieces of result data that can be regarded as having the substantially same departure and arrival points are grouped, and a mobility gap score can be determined for each group.

Further, for example, by integrating mobility gap scores calculated for the groups, respectively, a mobility gap score for the whole of a certain area can be calculated.

By calculating such a score for each area, it is possible to identify an area where the convenience in the case of using public transportation is lower in comparison with the case of using a private vehicle (it is also possible to identify an area where the convenience in the case of using a private vehicle is lower). That is, it becomes possible to, in order to improve convenience for movement, make a plan for providing new transportation means (for example, expanding car-sharing stations and the like).

The private vehicle is typically an automobile but may be a small-size vehicle like a personal mobility.

Specific embodiments of the present disclosure will be described below based on drawings. A hardware configuration, a module configuration, a function configuration, and the like described in each embodiment are not intended to limit the technical scope of the disclosure only thereto unless otherwise described.

### First Embodiment

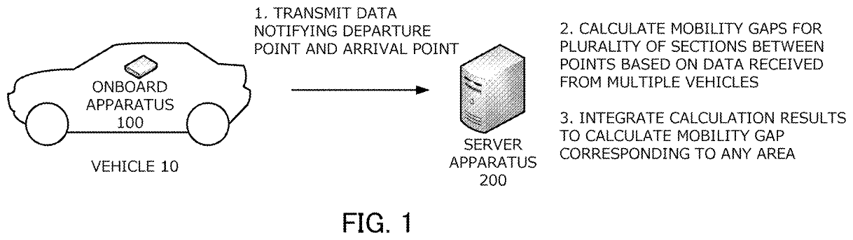

An overview of a vehicle system according to a first embodiment will be described with reference to FIG. 1. The vehicle system according to the present embodiment includes a vehicle 10 mounted with an onboard apparatus 100, and a server apparatus 200. The system may include a plurality of vehicles 10 (onboard apparatuses 100).

The vehicle 10 is a vehicle for collecting data about movement. The vehicle 10 is typically a private vehicle (that is, transportation means that can start movement at any timing). The vehicle 10 may be an autonomous vehicle or may be a vehicle driven by a driver.

The vehicle 10 is configured to be capable of wireless communication with the server apparatus 200 via the onboard apparatus 100 and can provide information for the server apparatus 200.

The server apparatus 200 is an apparatus that evaluates a mobility gap score based on data collected from the vehicle 10.

The mobility gap score is a numerical value indicating what degree of deviation there is between convenience of transportation means capable of moving in any section at any timing, such as a private vehicle, and convenience of transportation means for which an operation section and an operation schedule are decided, such as public transportation. For example, it is assumed that, in the case of moving in a certain section, fifteen minutes is required for a private vehicle, and forty-five minutes is required for public transportation. In this case, it can be said that there is a significant convenience deviation between both cases. Further, it is assumed that, in the case of moving in another section, fifteen minutes is required for a private vehicle, and fifteen minutes is also required for public transportation. In this case, it can be said that there is no difference in convenience between both.

The server apparatus 200 can calculate a mobility gap score by calculating times required in the case of moving in a predetermined section in private vehicles and times required in the case of moving in the same section in public transportation.

A mobility gap score can be calculated for each pair of a departure point and an arrival point. The server apparatus 200 calculates a mobility gap score for each of a plurality of sections for which there are movement results, based on data collected from the vehicles 10 which are private vehicles. Further, the server apparatus 200 integrates the calculated results to calculate an overall mobility gap score corresponding to a specified area. Thereby, it becomes possible to quantitatively evaluate an area where public transportation is inconvenient.

In the vehicle system according to the present embodiment, a plurality of onboard apparatuses 100 and the server apparatus 200 are mutually connected via a network. As the network, for example, a WAN (wide-area network) that is a worldwide public communication network, such as the Internet, or other communication networks may be adopted. Further, as the network, a telephone communication network for mobile phones and the like and a wireless communication network such as Wi-Fi (registered trademark) may be included.

Each of components constituting the system will be described.

The vehicles 10 are connected cars having a function of communication with an external network. The vehicles 10 are mounted with the onboard apparatuses 100.

Each onboard apparatus 100 is a computer for collecting information. In the present embodiment, the onboard apparatus 100 has a module for acquiring position information, and transmits data including acquired position information to the server apparatus 200 at a predetermined timing. The onboard apparatus 100 may be an apparatus that provides information for a driver of the vehicle 10 (for example, a car navigation apparatus) or may be an electronic control unit (ECU) that the vehicle 10 has. Further, the onboard apparatus 100 may be a data communication module (DCM) having a communication function.

Each onboard apparatus 100 can be configured as a computer that includes processors such as a CPU and a GPU, main memories such as a RAM and a ROM, auxiliary storage devices such as an EPROM, a hard disk drive, and a removable medium. In the auxiliary storage devices, an operating system (OS), various kinds of programs, various kinds of tables and the like are stored. By executing a program stored therein, each of functions meeting predetermined purposes as described later can be realized. A part or all of the functions may be realized by a hardware circuit like an ASIC and an FPGA.

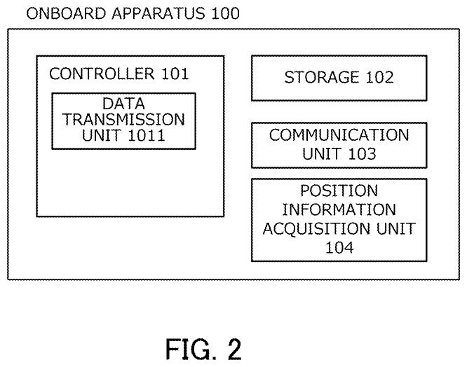

FIG. 2 is a diagram illustrating a system configuration of each onboard apparatus 100.

The onboard apparatus 100 includes a controller 101, a storage 102, a communication unit 103, and a position information acquisition unit 104.

The controller 101 is an arithmetic unit that realizes various kinds of functions of the onboard apparatus 100 by executing a predetermined program. The controller 101 may be realized, for example, by the CPU.

The controller 101 includes a data transmission unit 1011 as a function module. The function module may be realized by executing a stored program by the CPU.

The data transmission unit 1011 acquires position information about the onboard apparatus at a predetermined timing via the position information acquisition unit 104 to be described later, and transmits data including the position information to the server apparatus 200.

In the present embodiment, the data transmission unit 1011 acquires the position information at a timing when the travel system of the vehicle 10 is started and at a timing when the travel system of the vehicle 10 is shut down. Further, the data transmission unit 1011 transmits data including the information to the server apparatus 200 at the timing when the travel system of the vehicle 10 is shut down.

In the description below, a pair of a departure point and an arrival point will be referred to as a trip. That is, the data transmission unit 1011 transmits data for identifying a trip to the server apparatus 200. The data generated by the data transmission unit 1011 will be referred to as trip data below.

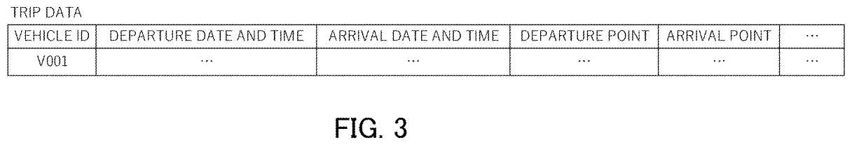

FIG. 3 illustrates an example of the trip data. As illustrated, the trip data includes a vehicle ID, a departure date and time, an arrival date and time, position information about a departure point, and position information about an arrival point. In a vehicle ID field, an identifier that uniquely identifies each vehicle 10 is stored. In a departure date and time field, a date and time when the vehicle 10 has left is stored. In an arrival date and time field, a date and time when the vehicle 10 has arrived is stored.

In each of departure point and arrival point fields, position information (for example, a latitude and a longitude) acquired by the position information acquisition unit 104 is stored.

In the present example, the data transmission unit 1011 transmits trip data at the timing when the travel system of the vehicle 10 is shut down. The trip data, however, may be transmitted at any timing. In this case, the trip data may include a plurality of records.

The storage 102 is a memory device that includes a main memory and an auxiliary storage device. In the auxiliary storage device, an operating system (OS), various kinds of programs, various kinds of tables and the like are stored. By loading a program stored therein to the main memory and executing the program, each of functions meeting predetermined purposes as described later can be realized.

The main memory may include a RAM (random access memory) and a ROM (read-only memory). The auxiliary device may include an EPROM (erasable programmable ROM) and an HDD (hard disk drive). Furthermore, the auxiliary storage device may include a removable medium, that is, a portable recording medium.

In the storage 102, the trip data generated by the controller 101 is temporarily stored.

The communication unit 103 is a wireless communication interface for connecting the onboard apparatus 100 to a network. The communication unit 103 is configured to be capable of communicating with the server apparatus 200 according to a communication standard, for example, a mobile communication standard, a wireless LAN communication, or Bluetooth (registered trademark).

The position information acquisition unit 104 includes a GPS antenna and a positioning module for acquiring position information. The GPS antenna is an antenna that receives a positioning signal transmitted from a positioning satellite (also referred to as a GNSS satellite). The positioning module is a module that calculates position information based on a signal received by the GPS antenna.

Next, a configuration of the server apparatus 200 will be described.

The server apparatus 200 can be configured as a computer that includes processors such as a CPU and a GPU, main memories such as a RAM and a ROM, auxiliary storage devices such as an EPROM, a hard disk drive, and a removable medium. In the auxiliary storage devices, an operating system (OS), various kinds of programs, various kinds of tables and the like are stored. By executing a program stored therein, each of functions meeting predetermined purposes as described later can be realized. A part or all of the functions may be realized by a hardware circuit like an ASIC and an FPGA. The server apparatus 200 may be configured with a single computer or may be configured with a plurality of computers cooperating with one another.

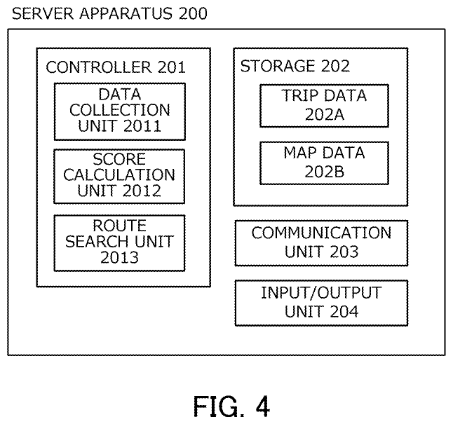

FIG. 4 is a diagram illustrating a system configuration of the server apparatus 200. The server apparatus 200 includes a controller 201, a storage 202, a communication unit 203, and an input/output unit 204.

The controller 201 is an arithmetic device in charge of control performed by the server apparatus 200. The controller 201 can be realized by an arithmetic processing device such as a CPU.

The controller 201 includes three function modules of a data collection unit 2011, a score calculation unit 2012, and a route search unit 2013. Each function module may be realized by executing a program stored in auxiliary storage means by the CPU.

The data collection unit 2011 executes a process for collecting pieces of trip data transmitted from the plurality of vehicles 10 (the onboard apparatuses 100) and storing the pieces of trip data into the storage 202 to be described later.

The score calculation unit 2012 calculates a mobility gap score based on the plurality of pieces of trip data stored in the storage 202. Specifically, for each of sections indicated by the plurality of pieces of trip data, an average value of times required in the case of moving in private vehicles and an average value of times required in the case of moving in public transportation are determined. Then, a ratio between the determined average values of required times is used as a mobility gap score corresponding to the section. Further, mobility gap scores determined for the sections are integrated to obtain a mobility gap score corresponding to a predetermined area.

A specific method will be described later.

In order to calculate a mobility gap score for a certain section, times required in the case of moving in the section in private vehicles and times required in the case of moving in public transportation are necessary. A time required in the case of moving in a section shown by trip data in a private vehicle is shown in the trip data. As for a time required in the case of moving in the section in public transportation, however, it is necessary to calculate the time using a route search service or the like.

The route search unit 2013 is configured to be capable of executing a route search service using public transportation, and determines a route and a time required in the case of moving in a specified section in public transportation.

The storage 202 includes a main memory and an auxiliary storage device. The main memory is a memory where a program executed by the controller 201 and data used by the control program are developed. The auxiliary storage device is a device in which programs executed by the controller 201 and data used by the control program are stored.

In the storage 202, trip data 202A and map data 202B are stored.

The trip data 202A is a set of a plurality pieces of trip data transmitted from the onboard apparatuses 100.

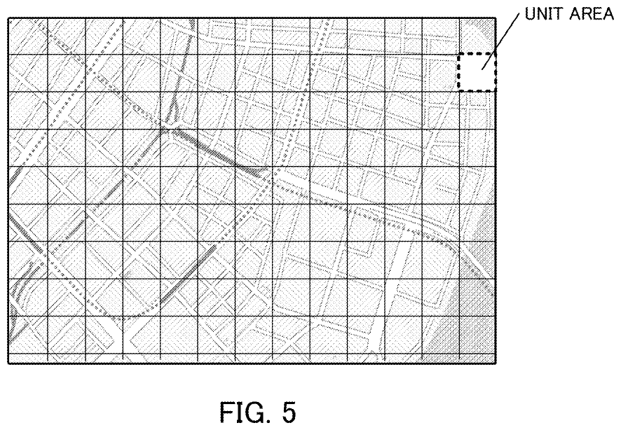

The map data 202B is map data of areas where the vehicles 10 can travel. In the present embodiment, the map data 202B is divided in a plurality of unit areas as illustrated in FIG. 5. The unit areas may be divided by a grid or based on geographical characteristics. Further, the unit areas may be divided for administrative divisions or for buildings.

The communication unit 203 is a communication interface for connecting the server apparatus 200 to a network. The communication unit 203 includes, for example, a network interface board and a wireless communication circuit for wireless communication.

The input/output unit 204 is means for accepting an input operation performed by a user of the apparatus and presenting information. In the present embodiment, the input/output unit 204 is configured with one touch panel display. That is, the input/output unit 204 is configured with a liquid crystal display and control means thereof, and a touch panel and control means thereof.

Note that the configurations illustrated in FIGS. 2 and 4 are mere examples, and all or a part of the illustrated functions may be executed with dedicatedly designed circuits. Further, storage and execution of the program may be performed by a combination of a main memory and an auxiliary storage device other than the illustrated combination.

Here, a flow of a process executed by the data collection unit 2011, the score calculation unit 2012, and the route search unit 2013 described before will be described in more detail.

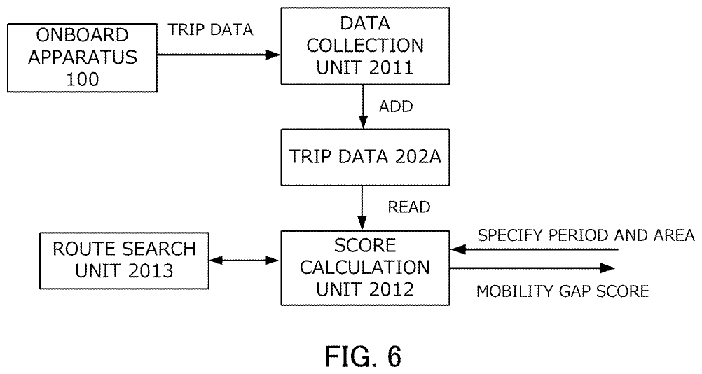

FIG. 6 is a diagram illustrating a flow of a process for calculating a mobility gap score based on pieces of trip data received from the vehicles 10.

When receiving a piece of trip data from each onboard apparatus 100, the data collection unit 2011 stores the piece of trip data into the trip data 202A.

The score calculation unit 2012 accepts specification of a period and an area from the user of the apparatus, acquires a plurality of pieces of trip data that occurred in the area during the period, and calculates a mobility gap score corresponding to the area based on the plurality of pieces of trip data.

Next, a mobility gap score calculation method implemented by the score calculation unit 2012 will be described.

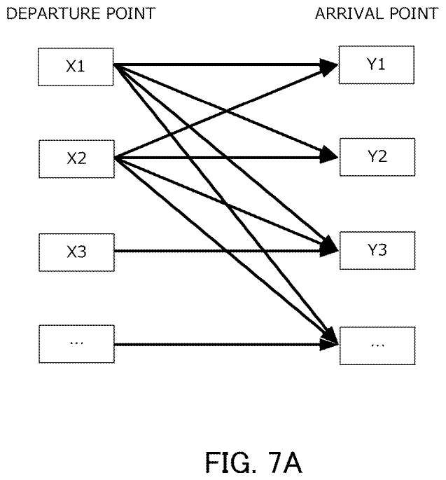

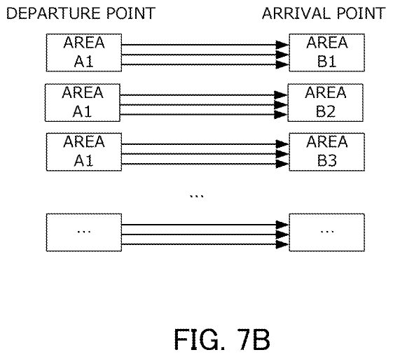

FIG. 7A is a diagram illustrating relationships between departure points and arrival points shown by a plurality of pieces of trip data. As illustrated, each of the plurality of pieces of trip data has a different pair of a departure point and an arrival point.

First, the score calculation unit 2012 extracts pieces of trip data the departure points of which are points in an area targeted by calculation of a mobility gap score (hereinafter, a target area) from among the plurality of pieces of trip data.

Next, the score calculation unit 2012 associates each of the departure points and the arrival points shown by the extracted plurality of pieces of trip data with any of the plurality of unit areas defined by the map data 202B (see FIG. 5). Then, trips of leaving the same unit area and arriving at the same unit area are grouped. Here, a unit area corresponding to the departure points will be referred to as a departure point area, and a unit area corresponding to the arrival points will be referred to as an arrival point area.

Hereinafter, a pair of a departure point area and an arrival point area will be referred to as an O/D (origin-destination).

Thereby, the plurality of trips are classified in groups as illustrated in FIG. 7B. A plurality of trips classified in the same group can be regarded as trips with the same departure point area and the same arrival point area.

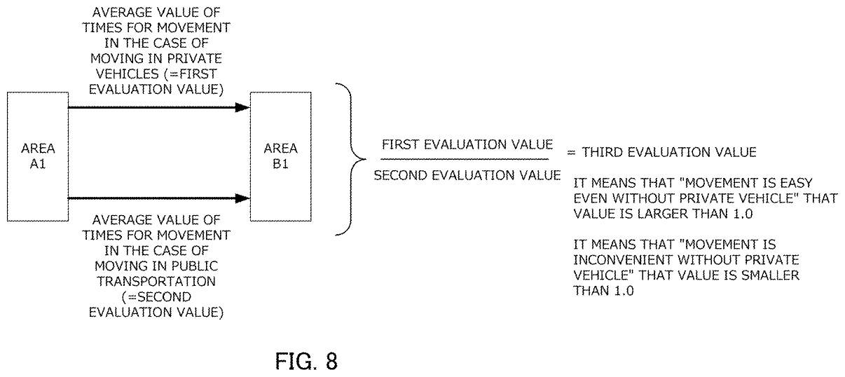

Next, an evaluation value is calculated for each of the plurality of O/Ds. FIG. 8 illustrates an example of calculating an evaluation value for a pair with an area Al and an area Bl as a departure point area and an arrival point area, respectively.

First, the score calculation unit 2012 determines an average value of times required in the case of going from the departure point area to the arrival point area in private vehicles. The average value of the required times is obtained by calculating an average of required times recorded in a plurality of pieces of trip data. The result is used as a first evaluation value.

Next, the score calculation unit 2012 determines an average value of times required in the case of going from the departure point area to the arrival point area in public transportation. The average value of the required times can be obtained based on a result of route search performed by the route search unit 2013. The result is used as a second evaluation value.

As departure times in performing route search, departure times shown in the piece of trip data may be used. For example, if there are pieces of trip data corresponding to five trips, route search may be performed five times on the assumption that the users left at the same departure times, and an average value of obtained required times may be determined.

Next, the score calculation unit 2012 acquires a value obtained by dividing the first evaluation value by the second evaluation value and uses the value as a third evaluation value. The third evaluation value means that convenience of public transportation is higher as the third evaluation value is larger than 1, and convenience of a private vehicle is higher as the third evaluation value is smaller than 1. The third evaluation value may be calculated by a method other than the above if the third evaluation value indicates a ratio between the first evaluation value and the second evaluation value. The third evaluation value may be calculated, for example, by dividing the second evaluation value by the first evaluation value.

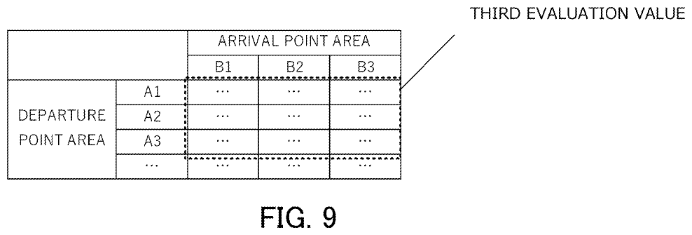

The score calculation unit 2012 executes the process illustrated in FIG. 8 for each of all the O/D pairs. As a result, as illustrated in FIG. 9, the third evaluation value is obtained for each of the pairs of departure point areas and arrival point areas.

Next, the score calculation unit 2012 integrates the plurality of third evaluation values obtained in this way to calculate a mobility gap score for the specified area.

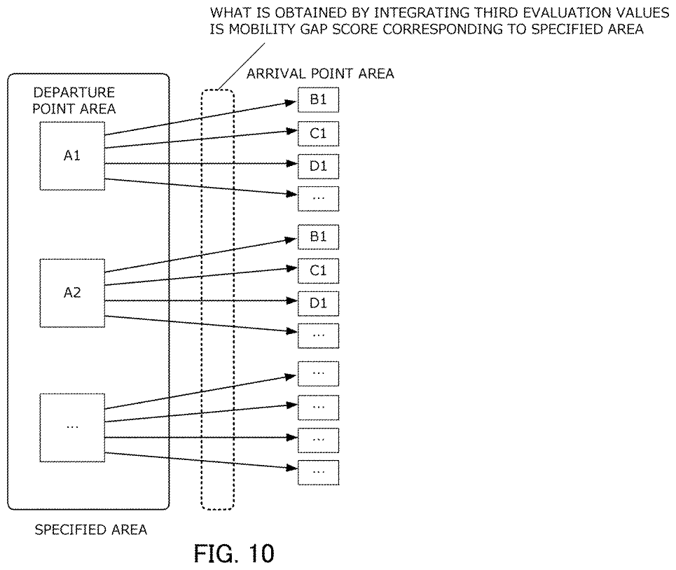

FIG. 10 is a schematic diagram of a process for calculating a mobility gap score corresponding to the specified area.

As described before, the departure points of all the plurality of pieces of trip data targeted by processing are within the specified area. Therefore, by integrating the third evaluation values (indicated by a dotted line) calculated for the trips, respectively, a mobility gap score corresponding to the specified area can be determined. The integration of the third evaluation values may be performed by determining an average value of the third evaluation values.

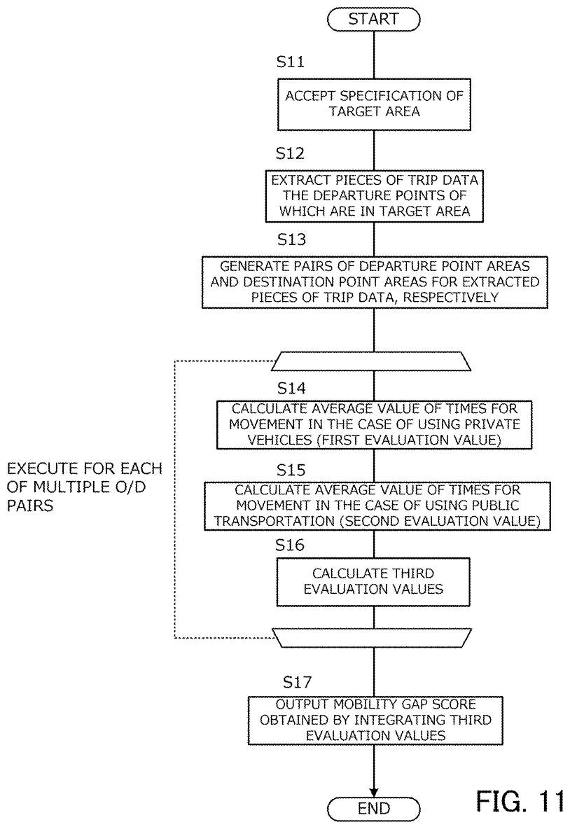

FIG. 11 is a flowchart of the process described with reference to FIGS. 7A to 10. The illustrated process is started by an operation of the user of the apparatus.

First, at step S11, specification of an area targeted by calculation of a mobility gap score (a target area) is accepted. The target area may be specified on a map or by other methods. For example, the target area may be set by specifying an administrative division or a building name.

Next, at step S12, pieces of trip data the departure points of which are points in the target area are extracted from among the stored plurality of pieces of trip data.

Next, at step S13, the departure points included in the extracted pieces of trip data are associated with unit areas defined by the map data 202B to obtain departure point areas. Further, arrival points included in the pieces of trip data are associated with unit areas defined by the map data 202B to obtain arrival point areas. Thereby, pairs of the departure point areas and the arrival point areas are generated.

Processes of steps S14 to S16 are executed for each of the pairs of the departure point areas and the arrival point areas (O/D pairs).

First, at step S14, an average value of times for movement in the case of, for a target O/D, moving in private vehicles is calculated. The times for movement are determined from dates and times recorded in the pieces of trip data. Thereby, a first evaluation value is obtained.

Next, at step S15, an average value of times for movement in the case of moving in public transportation for the target O/D is calculated. The times for movement can be obtained by using the route search service provided by the route search unit 2013. Thereby, a second evaluation value is obtained. The departure dates and times recorded in the piece of trip data may be used for dates and times of starting movement.

Next, at step S16, a third evaluation value is acquired by dividing the first evaluation value by the second evaluation value. Acquired third evaluation values are stored in association with the O/D pairs, respectively, as illustrated in FIG. 9.

At step S17, the obtained plurality of third evaluation values are integrated to obtain a mobility gap score corresponding to the target area. The score obtained here is outputted via the input/output unit 204.

As described above, in the vehicle system according to the first embodiment, an average value of times required in the case of moving in a predetermined section in private vehicles and an average value of times required in the case of moving in the predetermined section in public transportation are calculated based on pieces of trip data transmitted from the vehicles 10. Further, based on the average values, a score indicating a deviation between convenience in the case of moving in the private vehicles and convenience in the case of moving in the public transportation is calculated for a predetermined area.

Thereby, it is possible to, for each area, numericalize how inconvenient it is to move in public transportation in comparison with the case of using a private vehicle.

### Second Embodiment

In the first embodiment, all of the pieces of trip data the departure points of which are in a target area are acquired. A person's movement destination in an everyday life, however, significantly changes depending on gender, age, occupation and the like. Therefore, filtering of the pieces of trip data may be performed based on attributes of users.

A second embodiment is an embodiment in which filtering of the pieces of trip data is performed using attributes of users who performed movement.

In the second embodiment, user attributes are associated with the pieces of trip data. The user attributes may be given by the onboard apparatuses 100. In this case, a field in which a user attribute is to be stored is added to each piece of trip data. The user attributes may be given by the server apparatus 200. In this case, identifiers of the users may be included in the pieces of trip data, and the server apparatus 200 may give the user attributes based on the identifiers.

Further, in the second embodiment, specification of a target user attribute is accepted at step S11, and pieces of trip data having the specified user attribute are targeted by extraction at step S12. Thereby, it becomes possible to determine a mobility gap score corresponding to users having particular attributes about age, gender and the like (for example, “a male equal to or above sixty-five years of age).

### Third Embodiment

In the first embodiment, the third evaluation values are unconditionally integrated at step S17. However the value of movement may differ depending on a person's attributes or destination. For example, in a region with many elderly people, movement to a hospital may be more important than movement to other destinations. In a region with many students, movement to an educational facility may be more important than movement to other destinations.

In order to cope with the above, a third embodiment is an embodiment in which weights are set at the time of integrating third evaluation values according to the classifications of facilities in destinations (arrival points).

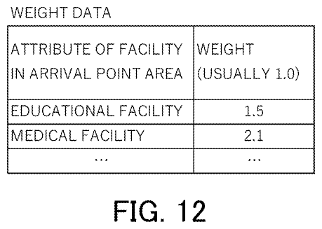

In the third embodiment, the server apparatus 200 stores data that defines weights used at the time of integrating third evaluation values (weight data). FIG. 12 illustrates an example of the weight data. The illustrated weight data is data in which attributes of facilities in arrival points area and weights are mutually associated. For example, in the illustrated example, movement to an educational facility and a medical facility are given large weights.

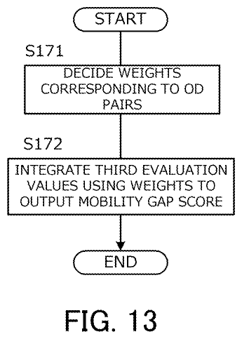

FIG. 13 is a flowchart illustrating a process executed at step S17 in the third embodiment in detail.

First, at step S171, a weight is decided for each of a plurality of O/D pairs with which third evaluation values are associated. At the present step, a facility included in each arrival point area is determined based on the map data 202B; and, if the facility is defined in the weight data, a corresponding weight is given. If a plurality of facilities are applicable, any of weights may be adopted, or the largest weight may be adopted. If none of facilities included in the arrival point area is defined in the weight data, the weight is 1.0. This process is performed for all the O/D pairs.

Then, at step S172, a weighted average is taken using the decided weight, and the plurality of third evaluation values are integrated.

Thus, according to the third embodiment, since a weight is decided based on a degree of importance of movement, it becomes possible to calculate a mobility gap score more appropriately.

### Modification of Third Embodiment

Though a weight is decided based on an attribute of a facility included in each arrival point area in the third embodiment, the weight may be decided based on other elements.

For example, a weight may be decided based on a magnitude of demand for each facility. The magnitude of a demand for each facility can be determined, for example, based on the number of visitors during a predetermined period in the past. The determination may be performed using pieces of trip data that occurred in the past. For example, if, for a certain O/D pair, the number of people who moved is larger than the other O/D pairs, a larger weight may be given to the O/D pair. That is, an O/D pair for which more movements have been performed may be considered to be more important.

Further, though the weight data is common in the third embodiment, different weight data may be used according to characteristics of a target area. For example, in an area where many elderly people reside, a larger weight may be given to movement to a medical facility. In an area where many children reside, a larger weight may be given to movement to a nursery school or a school. Which weight data is to be used for which area may be determined by the system or may be specified by the user of the apparatus.

Further, weight data may be defined for each of human attributes. For example, in the case of performing filtering of the pieces of trip data based on a user attribute, weight data corresponding to a specified user attribute may be acquired and used.

### Fourth Embodiment

Though pieces of trip data transmitted from the vehicles 10 are used to calculate a mobility gap score in the first to third embodiments, it is not necessarily required to use data transmitted from the vehicles 10 if departure and arrival points of users can be determined. For example, based on position information transmitted from a mobile terminal that a moving user carries, the user's departure point, arrival point, departure time, and arrival time may be determined. Further, the user's departure point, arrival point, departure time, and arrival time may be determined from usage records and electronic payment records of a transportation card that the user carries. Further, the server apparatus 200 may generate trip data based on the above data.

In the present embodiment, since there is not data about movements in private vehicles, required times for calculating first evaluation values cannot be obtained from pieces of trip data. Therefore, the route search unit 2013 may calculate routes and required times in the case of moving in private vehicles.

(Other Modifications)

The above embodiments are mere examples, and the present disclosure can be appropriately changed and implemented within a range not departing from its spirit.

For example, the processes and means described in the present disclosure can be freely combined and implemented as far as technical contradiction does not occur.

Further, though pieces of trip data the departure points of which are in a target area are extracted from among a plurality of pieces of trip data in the descriptions of the embodiments, pieces of trip data the arrival points of which are in a target area may be extracted. Thereby, a mobility gap score corresponding to transportation toward the target area can be determined.

When trips the departure points of which are in a target area are extracted, for example, information about “a place where people without a private vehicle are difficult to live” can be obtained. Further, when trips the arrival points of which are in a target area are extracted, for example, information about “a place that is difficult to go to by means other than a private vehicle” can be obtained.

Though a target area is specified by the user of the apparatus in the descriptions of the embodiments, the target area may be automatically set. For example, the process for determining a mobility gap score may be repeated for each of the unit areas illustrated in FIG. 5 as a target area. Thereby, a mobility gap score heat map can be generated. That is, it is possible to visualize in which area transportation means is to be supplemented.

Further, though required times are used as the first and second evaluation values in the descriptions of the embodiments, the first evaluation values may be calculated with an indicator other than required time if the first evaluation values are values that are larger as movement in private vehicles is more inconvenient. As such an indicator, movement costs (a toll, a fuel cost, and the like), required time bias (such as a probability of not arriving as scheduled) or the like can be also used. For the second evaluation values, an indicator other than required time may also be used if the indicator is such the values that are larger as movement in public transportation is more inconvenient. As such an indicator, a moving cost (a fare), the number of transfers, a waiting time that occurs by transfer, waiting time bias, or the like can be used. The first and second evaluation values may be values determined by calculating the above plurality of values in a predetermined method.

Processing described as being performed by one apparatus may be shared and executed by a plurality of apparatuses. Or alternatively, processing described as being performed by different apparatuses may be executed by one apparatus. In a computer system, what hardware configuration (server configuration) each function is realized by can be flexibly changed.

The present disclosure can be realized by supplying a computer program implemented with the functions described in the above embodiments to a computer, and one or more processors that the computer has reading out and executing the program. Such a computer program may be provided for the computer by a non-transitory computer-readable storage medium connectable to a system bus of the computer or may be provided for the computer via a network. As the non-transitory computer-readable storage medium, for example, a disk of a given type such as a magnetic disk (a floppy (R) disk, a hard disk drive (HDD) and the like) and an optical disc (a CD-ROM, a DVD disc, a Blu-ray disc and the like), a read-only memory (ROM), a random-access memory (RAM), an EPROM, an EEPROM, a magnetic card, a flash memory, an optical card, and a medium of a given type that is appropriate for storing electronic commands are included.

What is claimed is:

1. An information processing apparatus comprising a controller, the controller being configured to execute:
acquiring pieces of result data showing movement results of a plurality of users;
calculating at least either first evaluation values about convenience in a case of moving in predetermined sections in private vehicles or second evaluation values about convenience in a case of moving in the predetermined sections in public transportation at least based on the pieces of result data; and
calculating, for a predetermined area, a score indicating a deviation between convenience in the case of moving in the private vehicles and convenience in the case of moving in the public transportation based on the first and second evaluation values.

2. The information processing apparatus according to claim 1, wherein
the pieces of result data include pieces of position information about departure points and about arrival points.

3. The information processing apparatus according to claim 1, wherein
the convenience includes a time required for movement.

4. The information processing apparatus according to claim 2, wherein
the controller acquires the pieces of result data from a plurality of first vehicles that are private vehicles.

5. The information processing apparatus according to claim 4, wherein
the pieces of result data include pieces of position information about points where travel systems of the first vehicles are started and pieces of position information about points where the travel systems of the first vehicles are shut down.

6. The information processing apparatus according to claim 1, wherein
the controller targets pieces of result data having departure or arrival points that are in the predetermined area, for acquisition.

7. The information processing apparatus according to claim 6, wherein
the controller associates departure points and arrival points included in the plurality of pieces of result data with a plurality of areas defined in advance, and
calculates the first evaluation values and the second evaluation values for each pair of departure point areas corresponding to the departure points and arrival point areas corresponding to the arrival points.

8. The information processing apparatus according to claim 7, wherein
the first evaluation values are average values of times required for the movements of the plurality of users having moved in the private vehicles from the departure point areas to the arrival point areas shown by the pieces of result data.

9. The information processing apparatus according to claim 8, wherein
the second evaluation values are average values of times required for movements in the case of moving in the public transportation from the departure point areas to the arrival point areas shown by the pieces of result data.

10. The information processing apparatus according to claim 7, wherein
the controller calculates third evaluation values that are ratios of the first evaluation values to the second evaluation values for each pair of the departure point areas and the arrival point areas.

11. The information processing apparatus according to claim 10, wherein
the controller integrates the third evaluation values calculated for each pair of the departure point areas and the arrival point areas, and outputs a result of the integration as the score corresponding to the predetermined area.

12. The information processing apparatus according to claim 11, wherein
the controller performs the integration after giving weights corresponding to the arrival point areas to the plurality of third evaluation values.

13. The information processing apparatus according to claim 12, wherein
the weights are decided based on classifications of facilities included in the arrival point areas.

14. The information processing apparatus according to claim 12, wherein
the weights are decided based on magnitudes of demands for facilities included in the arrival point areas.

15. The information processing apparatus according to claim 1, wherein
the controller targets pieces of result data corresponding to users having a predetermined attribute for acquisition.

16. An information processing method comprising the steps of:
acquiring pieces of result data showing movement results of a plurality of users;
calculating at least either first evaluation values about convenience in a case of moving in predetermined sections in private vehicles or second evaluation values about convenience in a case of moving in the predetermined sections in public transportation at least based on the pieces of result data; and
calculating, for a predetermined area, a score indicating a deviation between convenience in the case of moving in the private vehicles and convenience in the case of moving in the public transportation based on the first and second evaluation values.

17. The information processing method according to claim 16, wherein
pieces of result data having departure or arrival points that are in the predetermined area are targeted for acquisition.

18. The information processing method according to claim 17, wherein
departure points and arrival points included in the plurality of pieces of result data are associated with a plurality of areas defined in advance, and
the first evaluation values and the second evaluation values are calculated for each pair of departure point areas corresponding to the departure points and arrival point areas corresponding to the arrival points.

19. The information processing method according to claim 18, further comprising the steps of:
calculating third evaluation values that are ratios of the first evaluation values to the second evaluation values for each pair of the departure point areas and the arrival point areas; and
integrating the third evaluation values calculated for each pair of the departure point areas and the arrival point areas, and outputting a result of the integration as the score corresponding to the predetermined area.

20. A non-transitory storage medium in which a program for causing a computer to execute the information processing method according to claim 16 is recorded.
